(19) United States
(12) Patent Application Publication
(10) Pub. No.: US 2010/0255366 A1
(43) Pub. Date: Oct. 7, 2010

(54) Insulin Cartridge Cap

(75) Inventor: Lawrence J. Myland, West Chester, PA (US)

Correspondence Address: PHILIP S. JOHNSON;JOHNSON & JOHNSON, ONE JOHNSON & JOHNSON PLAZA, NEW BRUNSWICK, NJ, 08933-7003, US

(73) Assignee: Animas Corporation, West Chester, PA (US)

(21) Appl. No.: 12/718,012

(22) Filed: Mar. 5, 2010

Related U.S. Application Data
(60) Provisional application No. 61/165,038, filed on Mar. 31, 2009.

(51) Int. Cl. H01M 2/08

(52) U.S. Cl. 429/175

(57) ABSTRACT

Described is a cartridge cap with a feature that aides in the removal of a battery cap from a drug infusion pump. The proximal end of the cartridge cap includes a recess on an inner surface that receives a tab on a distal end of the battery cap. To remove the battery cap from the drug infusion pump, the proximal end of the cartridge cap is placed over the distal end of the battery cap such that the recess in the cartridge cap receives the tab on the battery cap. The cartridge cap is then rotated counterclockwise until the battery cap is removed from the drug infusion pump.

### FIELD OF THE INVENTION

The present invention relates, in general, to cartridge caps used in drug delivery devices and, more particularly, to cartridge caps with a feature for removing a battery cap.

### BACKGROUND OF THE INVENTION

The use of drug delivery devices for various types of drug therapy is becoming more common as the automated infusion of a drug may provide more reliable and more precise treatment to a patient.

Diabetes is a major health concern, as it can significantly impede on the freedom of action and lifestyle of persons afflicted with this disease. Typically, treatment of the more severe form of the condition, Type I (insulin-dependent) diabetes, requires one or more insulin injections per day, referred to as multiple daily injections. Insulin is required to control glucose or sugar in the blood, thereby preventing hyperglycemia which, if left uncorrected, can lead to ketosis. Additionally, improper administration of insulin therapy can result in hypoglycemic episodes, which can cause coma and death. Hyperglycemia in diabetics has been correlated with several long-term effects of diabetes, such as heart disease, atherosclerosis, blindness, stroke, hypertension, and kidney failure.

The value of frequent monitoring of blood glucose as a means to avoid or at least minimize the complications of Type I diabetes is well established. Patients with Type II (non-insulin-dependent) diabetes can also benefit from blood glucose monitoring in the control of their condition by way of diet and exercise. Thus, careful monitoring of blood glucose levels and the ability to accurately and conveniently infuse insulin into the body in a timely manner is a critical component in diabetes care and treatment.

In order to more effectively control diabetes in a manner that reduces the limitations imposed by this disease on the lifestyle of the affected person, various devices for facilitating blood glucose (BG) monitoring have been introduced. Typically, such devices, or meters, permit the patient to quickly, and with a minimal amount of physical discomfort, obtain a sample of their blood or interstitial fluid which is then analyzed by the meter. In most cases, the meter has a display screen which shows the BG reading for the patient. The patient may then dose themselves with the appropriate amount, or bolus, of insulin. For many diabetics, this results in having to receive multiple daily injections of insulin. In many cases, these injections are self-administered.

Due to the debilitating effects that abnormal BG levels can have on patients, i.e., hyperglycemia, persons experiencing certain symptoms of diabetes may not be in a situation where they can safely and accurately self-administer a bolus of insulin. Moreover, persons with active lifestyles find it extremely inconvenient and imposing to have to use multiple daily injections of insulin to control their blood sugar levels, as this may interfere or prohibit their ability to engage in certain activities. For others with diabetes, multiple daily injections may simply not be the most effective means for controlling their BG levels. Thus, to further improve both accuracy and convenience for the patient, insulin infusion pumps have been developed.

Insulin pumps are generally worn on the patient's body, either above or below their clothing. These relatively small, unobtrusive devices typically store a quantity of insulin in a replaceable cartridge and include a processing unit, a display screen, and input functions such as buttons or a keypad. Such pumps may include the ability to run multiple insulin delivery programs, such as basal and bolus programs, to eliminate the need for injections of insulin via needles and syringes, by providing medication via an infusion device that can be worn by the patient for an extended period of time, usually in the range of 1-3 days.

While the convenience of an insulin pump has helped to improve the lifestyle of diabetics and has lessened the impact of their disease on their normal activity, advances in insulin pumps are still needed. For example, when the battery needs to be replace, the user must find a tool to remove the battery cap. Typically, users use a coin to open the battery cap. However, using a coin to open the battery cap may be difficult for users with arthritis or weakened motor skills.

Therefore, it would be desirable for patients to have a tool that facilitates easy removal of the battery cap and that is a component of the insulin pump.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 is a perspective view of an insulin cartridge cap and a battery cap according to an exemplary embodiment of the present invention;

FIG. 2 is a perspective view of an insulin pump that may be used with the cartridge cap and battery cap shown in FIG. 1;

FIG. 3 is a perspective view of the cartridge cap shown in FIG. 1 being used to remove the battery cap shown in FIG. 1 from an insulin pump; and

FIG. 4 is a top view of the battery cap shown in FIG. 1.

### DETAILED DESCRIPTION OF ILLUSTRATIVE EMBODIMENTS OF THE INVENTION

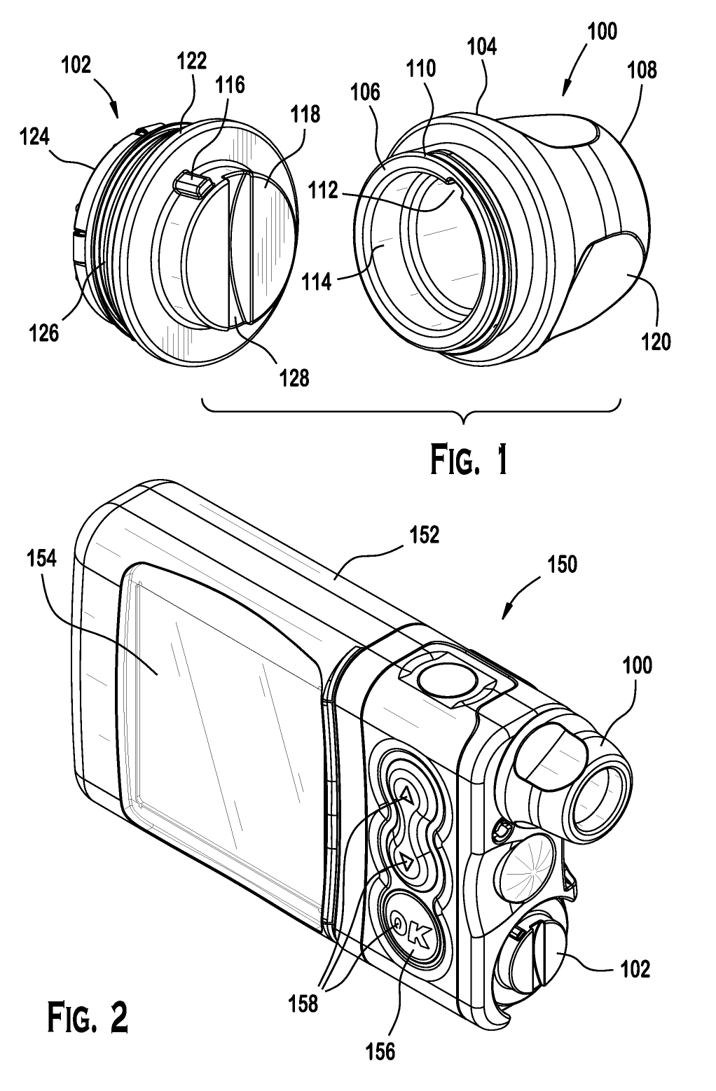

FIG. 1 illustrates an insulin cartridge cap 100 and a battery cap 102 according to an exemplary embodiment of the present invention. The cartridge cap 100 includes a body 104 having a proximal end 106 and a distal end 108. The proximal end 106 includes threads 110 that mate with threads in an insulin cartridge chamber (not shown) of a drug infusion pump 150 (shown in FIG. 2). The proximal end 106 also includes a recess 112 on an inner surface 114 that receives a tab 116 on a distal end 118 of the battery cap 102.

The distal end 108 of the cartridge cap 100 may include indentations 120 to aid in gripping the cartridge cap 100.

The battery cap 102 includes a body 122, the distal end 118 and a proximal end 124. The proximal end 124 includes threads 126 that mate with threads in a battery chamber (not shown) of the drug infusion pump 150. The distal end may 118 optionally include a groove 128 into which a coin can be inserted for removal of the battery cap 102 (see FIGS. 1 and 4).

An exemplary embodiment of a drug infusion pump 150 (e.g., an insulin pump) that may incorporate the cartridge cap 100 and the battery cap 102 of the present invention is illustrated in FIG. 2. The drug infusion pump 150 includes a housing 152, a display 154 for providing operational information to the user, a keypad 156 with a plurality of navigational buttons 158 for the user to input information, a battery in a compartment (not shown) with a battery cap 102 for providing power to the drug infusion pump 150, processing electronics (not shown), a drug delivery mechanism (e.g., an insulin pump and drive mechanism; not shown) for forcing a drug from a cartridge in a chamber with a cartridge cap 100, through a side port (not shown) connected to an infusion set (not shown) and into the body of the user.

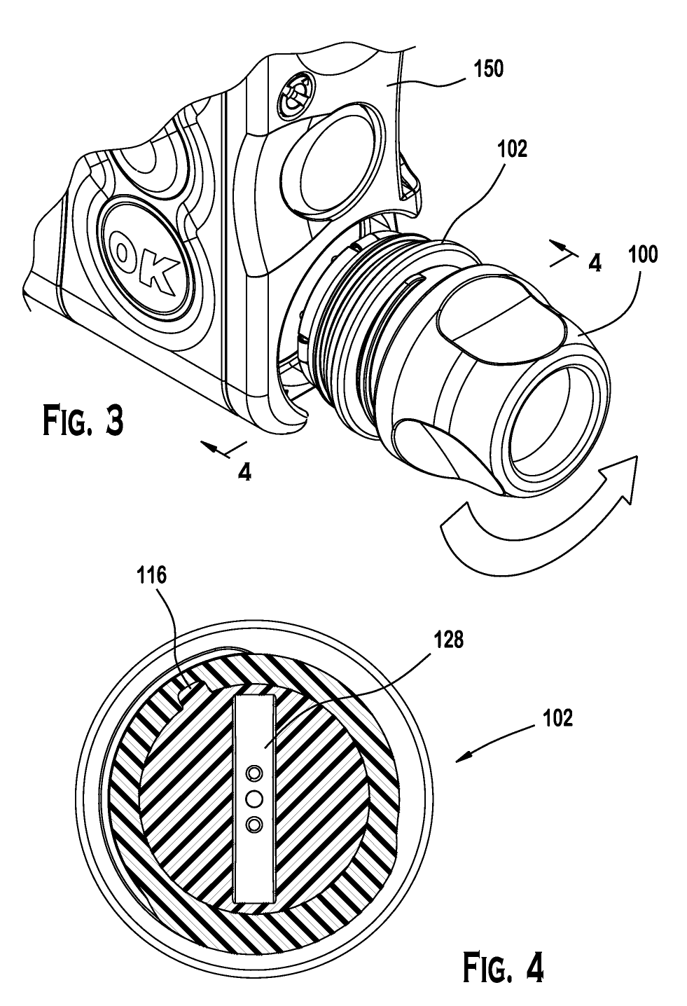

To use the cartridge cap 100 as a tool to remove the battery cap 102, the cartridge cap 100 is removed from the insulin cartridge chamber of the infusion pump and is placed on the battery cap 102. The cartridge cap 100 is then rotated either clockwise or counterclockwise until the recess 112 is aligned and mated with the tab 116 on the battery cap 102. As shown in FIG. 3, after the recess 112 is mated with the tab 116, the cartridge cap 100 is rotated counterclockwise until the battery cap 102 is removed.

It will be recognized that equivalent structures may be substituted for the structures illustrated and described herein and that the described embodiment of the invention is not the only structure, which may be employed to implement the claimed invention. In addition, it should be understood that every structure described above has a function and such structure can be referred to as a means for performing that function. While embodiments of the present invention have been shown and described herein, it will be obvious to those skilled in the art that such embodiments are provided by way of example only. Numerous variations, changes, and substitutions will now occur to those skilled in the art without departing from the invention.

It should be understood that various alternatives to the embodiments of the invention described herein may be employed in practicing the invention. It is intended that the following claims define the scope of the invention and that methods and structures within the scope of these claims and their equivalents be covered thereby.

What is claimed is:

1. An medical device, comprising:
a housing having a cartridge cavity therein;
a cartridge capable of containing a quantity of fluid, wherein the cartridge cavity receives the cartridge;
a cartridge cap that is removably attachable to the cartridge cavity;
a battery cavity for receiving a battery;
a battery cap that is removably attachable to the battery cavity, and
wherein the battery cap and cartridge cap each have at least one interlocking feature to permit the battery cap and cartridge cap to interlock and for the cartridge cap to be used as a tool to remove or affix the battery cap to the battery cavity.
